(19) United States
(12) Patent Application Publication
(10) Pub. No.: US 2015/0287060 A1
(43) Pub. Date: Oct. 8, 2015

(54) PRODUCT SCORE METHOD AND SYSTEM

(71) Applicant: Indix Corporation, Seattle, WA (US)

(72) Inventors: Sanjay PARTHASARATHY, Bellevue, WA (US); Sampath Kumar JAGANNATHAN, Chennai (IN); Anirudh VENKATRAMAN, Chennai (IN); Mohammed J. ZAHOOR, Chennai (IN); Satyanarayana Rao KALIKIVAYI, Chennai (IN)

(21) Appl. No.: 14/656,554

(22) Filed: Mar. 12, 2015

Related U.S. Application Data
(63) Continuation-in-part of application No. 13/951,248, filed on Jul. 25, 2013.
Application No. 13/951,248 is a continuation-in-part of application No. 13/951,244, filed on Jul. 25, 2013, now Pat. No. 9,047,614.
(60) Provisional application No. 61/952,029, filed on Mar. 12, 2014.
(60) Provisional application No. 61/952,004, filed on Mar. 12, 2014.

(51) Int. Cl. G06Q 30/02; G06Q 50/00

(52) U.S. Cl. CPC G06Q 30/0202; G06Q 30/0206; G06Q 30/0276; G06Q 50/01

(57) ABSTRACT

Disclosed in one embodiment is a method implemented in a computer system for determining a score of a product.

### CROSS-REFERENCE TO RELATED APPLICATIONS

This application claims the benefit of U.S. Provisional Patent Application Ser. No. 61,952,004, filed on Mar. 12, 2014, and U.S. Provisional Patent Application Ser. No. 61,952,029, filed on Mar. 12, 2014, and is a continuation-in-part of U.S. application Ser. No. 13/951,248, filed Jul. 25, 2013, PCT Application Number PCT/US13/52108, filed Jul. 25, 2013, U.S. application Ser. No. 13/951,244, filed Jul. 25, 2013, and PCT Application Number PCT/US13/52106, filed Jul. 25, 2013, which applications claim the benefit of U.S. Provisional Application Ser. No. 61/675,492, filed on Jul. 25, 2012. All of the foregoing applications and child applications thereof are incorporated herein, in their entirety, for all purposes.

### FIELD

This disclosure is directed to software, and more particularly, to assigning a score to products.

### BACKGROUND

Search engines assign ranked scores, commonly called link scores, to URIs based on links to and from the URI and based on the number of links to and from the linking URIs. Citation scores rank scientific articles based on the number and type of citations made to the article.

Products are sometimes associated with scores such as a sales rank, but these scores do not capture a host of values which might be used to score a product, such as (without listing all such metrics and without requiring that all of any of these examples be included in a product score) consumer sentiment regarding the product, consumer sentiment regarding the stores where the product is sold, price volatility of the product, whether and how long the product has been on promotion.

### BRIEF DESCRIPTION OF THE DRAWINGS

FIG. 1 is a network and device diagram illustrating exemplary computing devices in an environment configured according to embodiments disclosed in this paper.

FIG. 2 is a functional block diagram of an Indix Server.

FIG. 3 is a functional block diagram of an Indix Database.

FIG. 4 illustrates an embodiment of a Product Score Process, in which a Product Score is determined and utilized.

FIG. 5 illustrates a Demand Signal Determination Process, in which a Demand Signal is determined.

FIG. 6 illustrates a Supply Signal Determination Process, in which a Supply Signal is determined.

FIG. 7 illustrates a Social Signal Determination Process, in which a Social Signal is determined.

FIG. 8 illustrates a Quality Signal Determination Process, in which a Quality Signal is determined.

FIG. 9 illustrates a Product-Type Quantity Signal Determination Process, in which a Product-Type Quantity Signal is determined.

FIG. 10 illustrates an embodiment of a Brand Score Determination Process, in which a Brand Score is determined.

FIG. 11 illustrates an embodiment of a Store Score Determination Process, in which a Store Score is determined.

### DETAILED DESCRIPTION

The following description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list. Certain computer software routines executed by computers are described herein as “routines” or “subroutines.” It should be understood that “routines” may be performed within other routines and that “subroutines” may be executed independent of another routine or subroutine; the two terms are used herein for the sake of convenience and should be understood to be equivalent.

As used herein, “Product” shall be understood to mean “product” or “service.” As used herein, an “iPID” is a unique identifier assigned to a URI for a Product or at which a Product may be purchased; the iPID may be a hash of the URI for the Product. iPID 330 is a record in the Indix Database 300 for the iPID. As used herein, an “MPID” or “Master iPID” is a iPID 330 which is assigned to a Product by, for example, the “MPID Assigner Routine 1200” of U.S. patent application Ser. No. 13/951,244 and PCT Application Number PCT/US13/52106. Assignment of an MPID may take into account, for example, when a Vendor sells the same Product at multiple URIs on the Vendor's website, when the product is being sold “new” or “used” and various other factors. An MPID is generally meant to identify a single Product across multiple URIs, the single Product generally being produced by or associated with a common manufacturer or wholesale producer, though the Product may be distributed and sold by multiple parties.

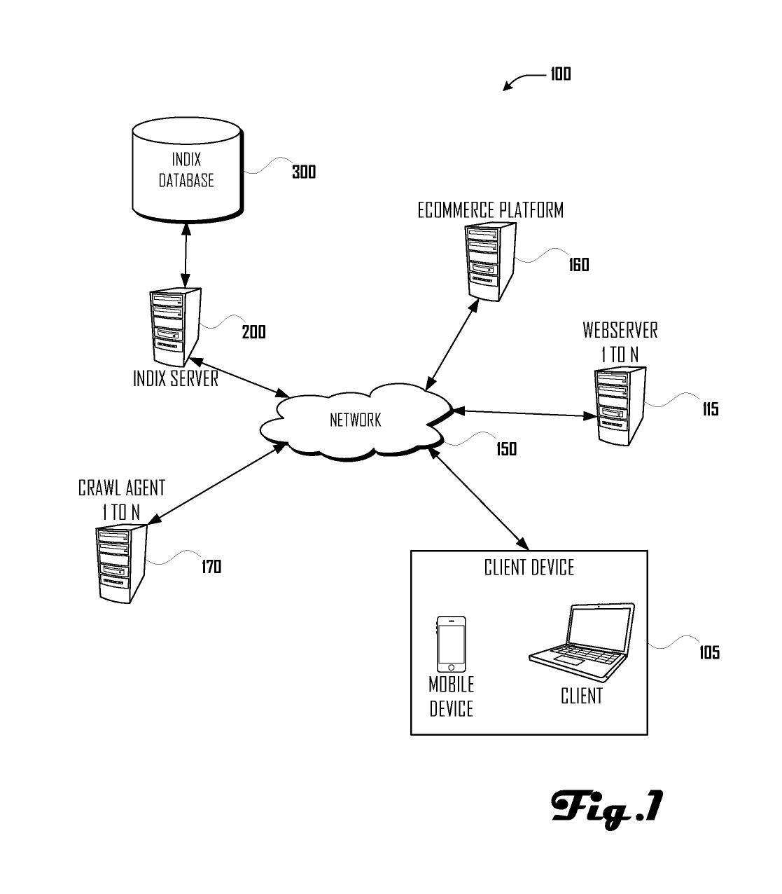

FIG. 1 is a network and device diagram illustrating an exemplary computing environment 100 configured according to exemplary embodiments. The servers, computing devices and databases illustrated in FIG. 1—such as Indix Server 200, Indix Database 300, Client Device 105, Webserver 115, Crawl Agent 170, and Ecommerce Platform 160—may be provided by common (or separate) physical hardware and common (or separate) logic processors and memory components. As used herein, “database” should be understood as a physical or logical place where data is stored.

In the computing environment 100 is Indix Server 200 connected to Network 150, such as the Internet, a private network, local area network (LAN), or the like.

Indix Server 200 executes Product Score Process 400 to determine a Product Score 391 for Products. In executing the Product Score Process 400, the Indix Server 200 may utilize records representing signals such as, for example, Demand Signal 301, Supply Signal 302, Social Signal 303, Quality Signal 304, and Product-Type Quantity Signal 306. These records may be determined by execution of, for example, a Demand Signal Determination Process 500, a Supply Signal Determination Process 600, a Social Signal Determination Process 700, a Quality Signal Determination Process 800, and a Product-Type Quantity Signal Determination Process 900. Certain of the foregoing process may further utilize a Brand Score 392 and a Store Score 393. The Brand Score 392 may be determined by a Brand Score Determination Process 1000; the Store Score 393 may be determined by a Store Score Determination Process 1100.

To obtain the information used by these processes, Indix Server 200 executes other process to interact with i) Crawl Agent 170 to obtain information regarding Products from Ecommerce Platform 160, and ii) with Webserver 115 to obtain other information. Information regarding a Product may be obtained via a URI, such as URI 305 (which is associated with an iPID 330), which is followed by Crawl Agent 170 to Ecommerce Platform 160 and which is used to obtain URI-Content Instance 310. The URI-Content Instance 310 may be parsed to obtain Product Attributes 345 and Price Attributes 340. Processes for obtaining this information are further described in U.S. application Ser. No. 13/951,244, PCT Application Number PCT/US13/52106, U.S. application Ser. No. 13/951,248, and PCT Application Number PCT/US13/52108. A user interface for presenting the output of analysis of this information is further described in in U.S. application Ser. No. 61/952,004, and child applications thereof.

Network 150 comprises computers, network connections among the computers, and software routines to enable communication between the computers over the network connections.

Also illustrated in FIG. 1 is Webserver 115 connected to Network 150. Webserver 115 represents, for example, a service provider, such as a provider of network services, a social network service provider, and other service providers. Webserver 115 may be implemented by a general purpose computer similar to Indix Server 200.

Also illustrated in FIG. 1 is Client Device 105 connected to Network 150. Client Device 105 represents, for example, a party who obtains information and services from Indix Server 200 and processes executed by Indix Server 200. Client Device 105 may be implemented by a general purpose computer similar to Indix Server 200.

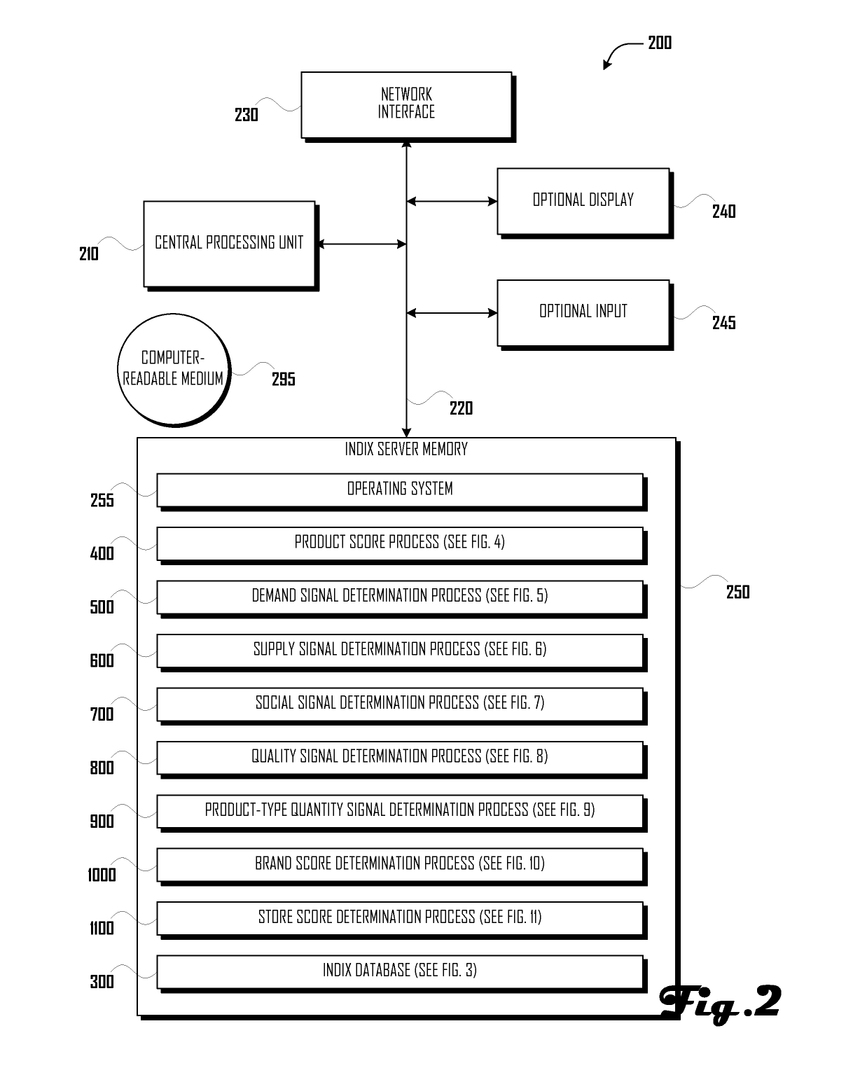

FIG. 2 is a functional block diagram of an exemplary Indix Server 200 computing device and some data structures and/or components thereof. In some embodiments, Indix Server 200 may include many more components than those shown in FIG. 2. However, it is not necessary that all of these generally conventional components be shown in order to disclose an illustrative embodiment. As shown in FIG. 2, Indix Server 200 includes network interface 230 for connecting to Network 150.

Indix Server 200 also includes at least one processing unit 210, memory 250, and an optional display 240, all interconnected along with the network interface 230 via a bus 220. Memory 250 generally comprises a random access memory (“RAM”), a read only memory (“ROM”), and a permanent mass storage device, such as a disk drive or SDRAM (synchronous dynamic random-access memory). Memory 250 stores program code for software routines, such as, for example, Product Score Process 400, Demand Signal Determination Process 500, Supply Signal Determination Process 600, Social Signal Determination Process 700, Quality Signal Determination Process 800, Product-Type Quantity Signal Determination Process 900, Brand Score Determination Process 1000, Store Score Determination Process 1100, as well as browser, email servers, client applications, and database applications. In addition, memory 250 also stores an operating system 255. These software components may be loaded from a non-transient computer readable storage medium 295 into memory 250 of Indix Server 200 using a drive mechanism (not shown) associated with a non-transient computer readable storage medium 295, such as a floppy disc, tape, DVD/CD-ROM drive, memory card, or other like storage medium. In some embodiments, software components may also or instead be loaded via a mechanism other than a drive mechanism and computer readable storage medium 295 (e.g., via network interface 230).

Indix Server 200 may also comprise hardware supporting optional input modalities, Optional Input 245, such as, for example, a touchscreen, a keyboard, a mouse, a trackball, a stylus, a microphone, and a video and/or still camera.

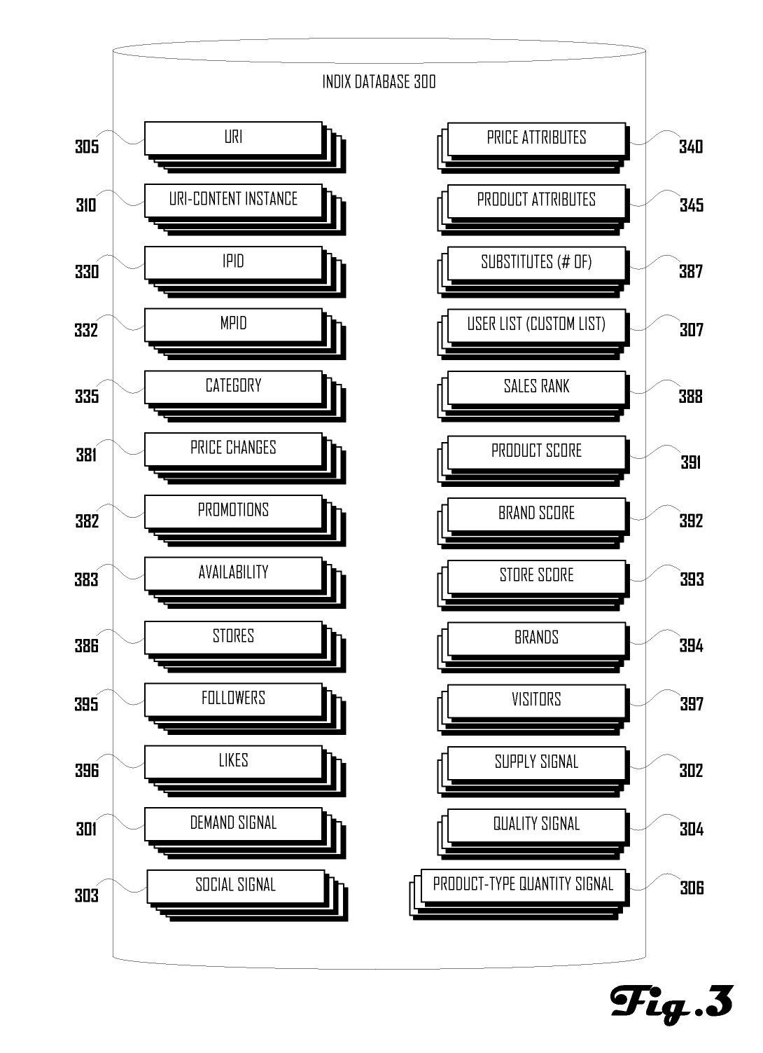

Computing device 200 also comprises or communicates via bus 220 with Indix Database 300, illustrated further in FIG. 3. In various embodiments, bus 220 may comprise a storage area network (“SAN”), a high speed serial bus, and/or via other suitable communication technology. In some embodiments, Indix Server 200 may communicate with Indix Database 300 via network interface 630.

FIG. 3 is a functional block diagram of Indix Database 300. Indix Database 300 comprises data groups used by routines, such as URI 305, URI-Content Instance 310, iPID 330, MPID 332, Category 335, Price Attributes 340, Product Attributes 345, Price Changes 381, Promotions 382, Availability 383, Stores 386, Substitutes 387, User List 307, Sales Rank 388, Product Score 391, Brand Score 392, Store Score 393, Brands 394, Followers 395, Likes 396, Visitors 397, as well as “Signal Scores,” such as Demand Signal 301, Supply Signal 302, Social Signal 303, Quality Signal 304, Product-Type Quantity Signal 306, and the like. As discussed below, Signal Scores may also be referred to as “metrics”, as in Demand Signal 301 being referred to as a “demand metric”.

The data groups used by routines may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar. Data groups used by routines are also referred to herein as “records.”

The software routines and data groups used by the software routines may be stored and/or executed remotely relative to any of the computers through, for example, application virtualization.

Login credentials (such as a username and password) may be stored in or be accessible to Indix Server 200, Crawl Agent 170, Ecommerce Platform 160, Webserver 115, and Client Device 105.

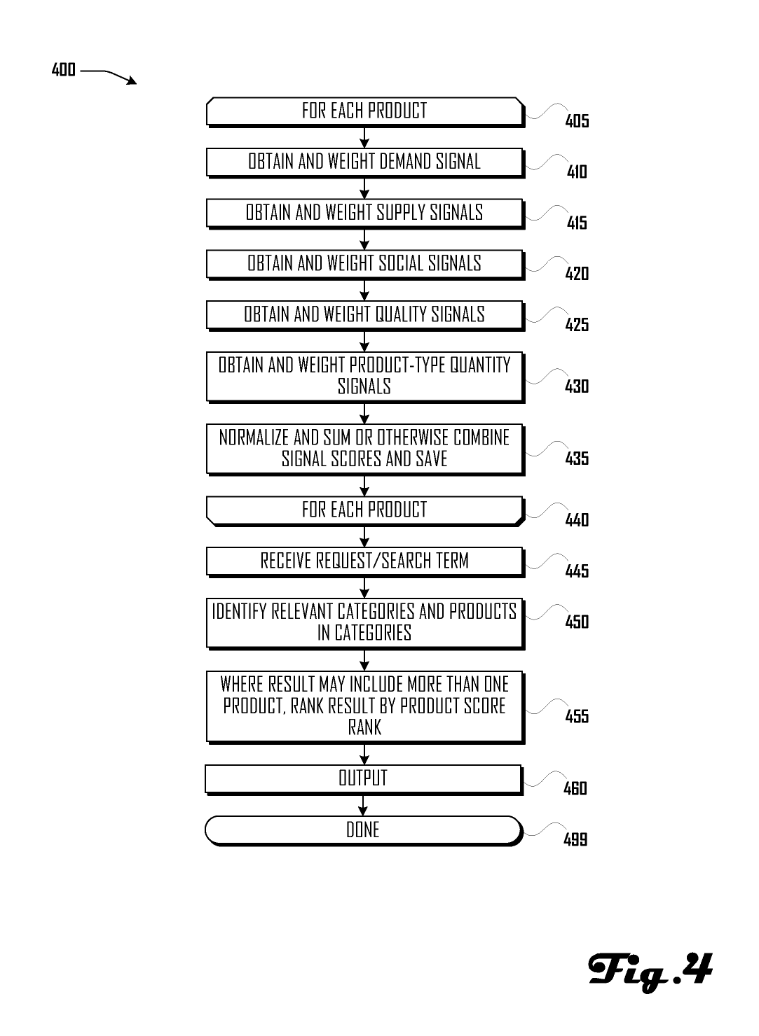

FIG. 4 illustrates an embodiment of a Product Score Process 400, in which a Product Score 391 is determined. Blocks 405 to 435 may iterate for each Product. What are separate Products may determined by, for example, an MPID 332 assigned to each of the separate Products. Other ways to distinguish Products may be used, such as according to information from Brands 394. In each of blocks 410 through 430, a Signal Score or the like is obtained and, if not already weighted, the Signal Score is weighted. At block 435, the weighted Signal Scores are summed or otherwise combined, producing one composite Product Score 391 for the Product. Weighting the Signal Scores may be accomplished by, for example, multiplying each Signal Score by a percentage. Together, the percentages may add up to 100.

The following examples of Signal Score categories are used herein: Demand, Supply, Social, Quality, and Quantity. Other categories may be utilized and the data determining metrics in each of these (or other) categories may be organized, processed in other arrangements, replaced by different data, or dropped entirely.

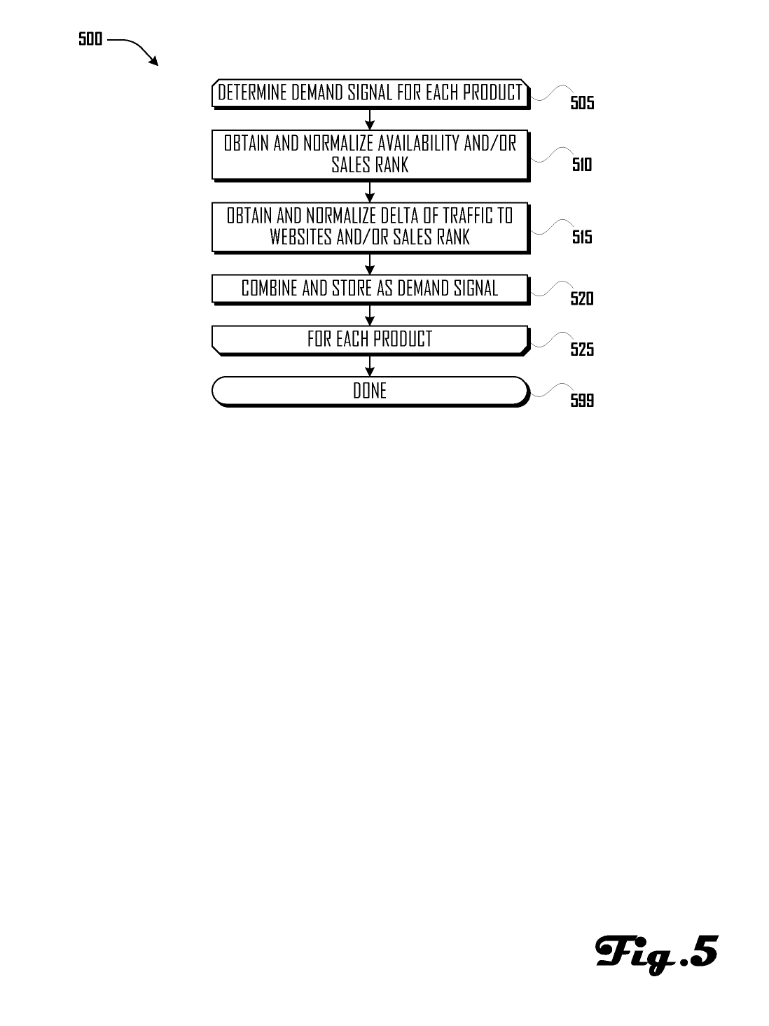

At block 410 Demand Signal 301 is obtained and weighted. Demand Signal 301 is generally intended to comprise signals indicative of demand for the Product, such as whether demand for the Product is increasing or decreasing, whether demand is elastic or inelastic, and the like. As an example, FIG. 5 illustrates Demand Signal Determination Process 500, in which Demand Signal 301 is determined.

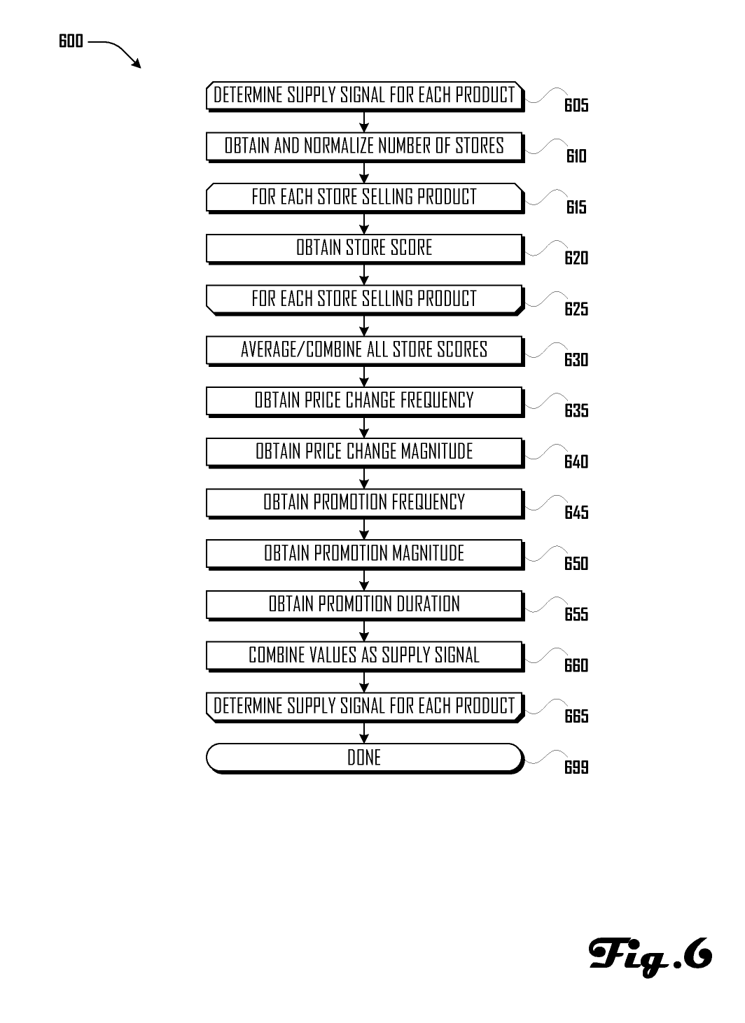

At block 415, Supply Signal 302 is obtained and weighted. Supply Signal 302 is generally intended to comprise signals indicative of the supply for the Product, such as whether the supply of a Product is increasing or decreasing, whether the change in supply is happening in conjunction with or opposite of a change in demand, and the like. As an example, FIG. 6 illustrates Supply Signal Determination Process 600, in which Supply Signal 302 is determined.

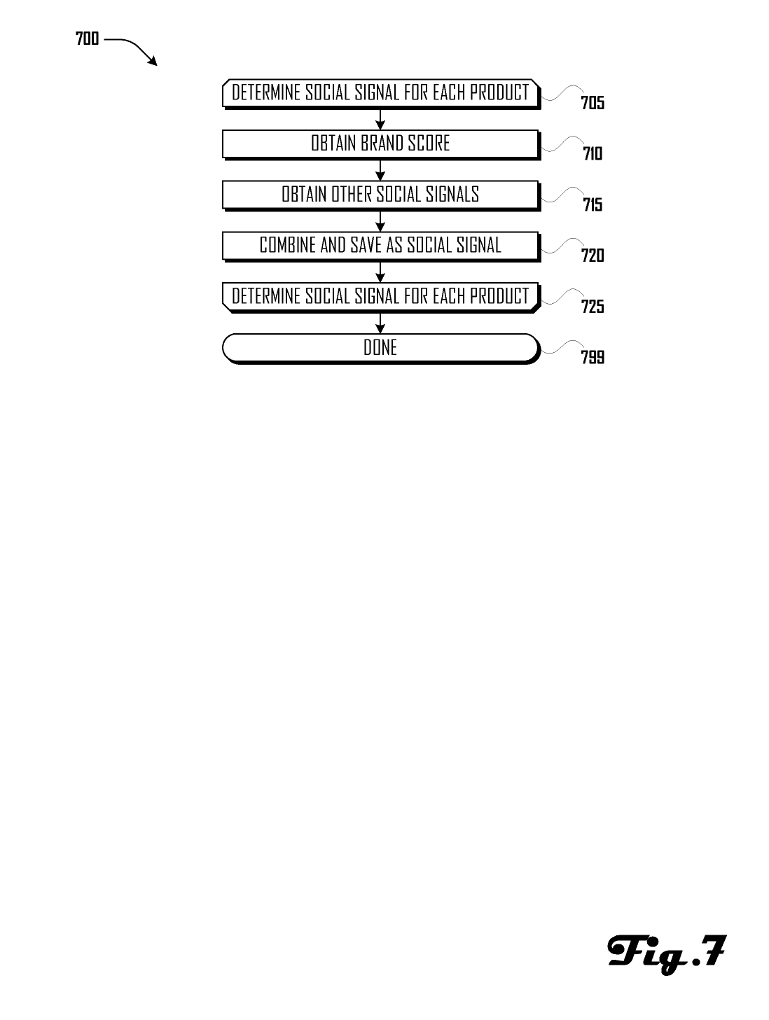

At block 420, Social Signal 303 is obtained and weighted. Social Signal 303 is generally intended to comprise signals indicative of social sentiment in relation to the Product. As an example, FIG. 7 illustrates Social Signal Determination Process 700, in which Social Signal 303 is determined.

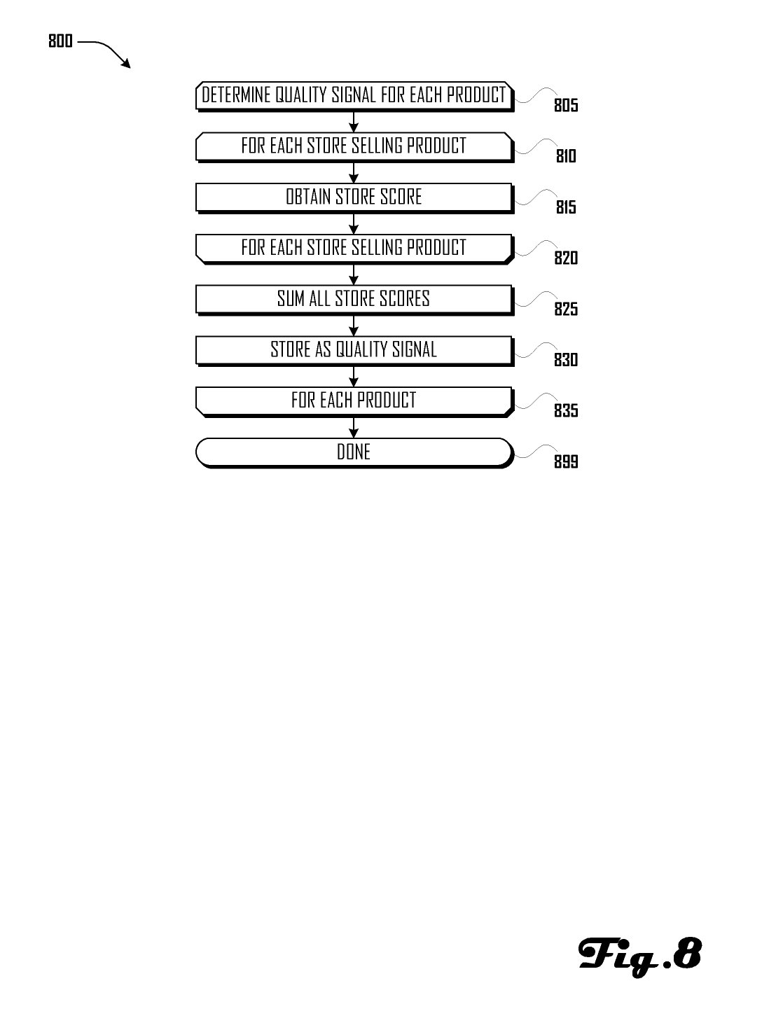

At block 425, Quality Signal 304 is obtained and weighted. Quality Signal 304 is generally intended to comprise signals indicative of the quality or perceived quality of the Product. As an example, FIG. 8 illustrates Quality Signal Determination Process 800, in which Quality Signal 304 is determined.

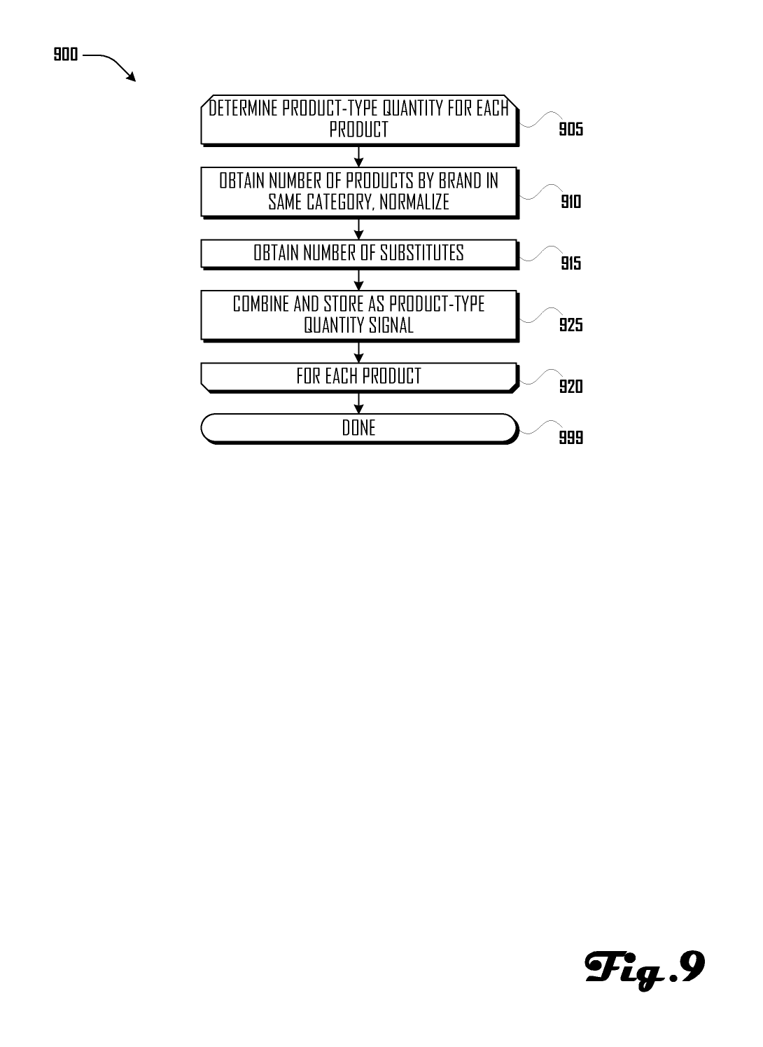

At block 430, Product-Type Quantity Signal 306 is obtained and weighted. Product-Type Quantity Signal 306 is generally intended to comprise signals indicative of the quantity of types of the Product. As with other of the Signal Scores, this is a signal which may, as illustrated, be provided with its own category or might be included in another Signal Score, such as in the Supply or Demand Signal Score categories. As an example, FIG. 9 illustrates Product-Type Quantity Signal Determination Process 900, in which Product-Type Quantity Signal 306 is determined.

As noted above, at bock 435, the weighted Signal Scores of blocks 410 through 430 are summed or otherwise combined and saved as Product Score 391.

At block 440, Product Score Process 400 returns to iterate over the next Product or, at block 499, may conclude if no additional Products remain.

At block 445, a request, such as a search term, relating to a Product or Category 335 may be received, such as, for example, “shoes”.

At block 450, relevant Categories 335 and Products relating to the request or search term may be identified. This may be according to a presence vector and an intent vector. The presence vector may determine how frequently the search term or request (and synonyms thereof) appear in a categorization schema, such as a schema of Categories 335. In the case of a popular smart phone, the results may include more Categories relating to phone accessories than relating to the smart phone itself, because there are more categories of accessories than there are for the phone, itself. This type of bias may be corrected or adjusted for through the use of the intent vector. The intent vector may utilize an algorithm, such as a trained, supervised learning algorithm, to determine a set of products which are most often the desired result of the search term, within the set determined according to the presence vector. The intent vector may be trained with the results of other search engines and of human input.

At block 455, when the result of block 450 contains more than one Product, the results may be ranked according to Product Score 391.

At block 460, the ranked result may be output, such as to guide the response of a search engine to the input request or search term. The output may be by, for example, Indix Server 200, Ecommerce Platform 160, Webserver 115, and the like.

At block 499, Product Score Process 400 may conclude or may return to another process which may have called it.

FIG. 5 illustrates an example of Demand Signal Determination Process 500, in which Demand Signal 301 is determined. Blocks 505 through 525 may iterate for each Product for which new data is available.

At block 510, the availability and/or availability delta of the Product may be determined, such as according to Availability 383 record. Availability 383 record may be derived from whether the Product is listed as being “available,” “for sale,” “out of stock,” “back ordered,” or the like (according to information obtained by the Crawl Agent 170) on websites listing the Product for sale. The number of websites listing the Product for sale may be determined from the number of iPIDs 330 associated with the Product. The value of the Availability 383 record may be normalized relative to the total number of websites listing the Product for sale. The delta in availability may be determined according to whether the Product availability has been trending upward (greater availability) or downward (toward less availability). The value of block 510 may be normalized, such as relative to availability across all Products or relative to Products in a Category 335 in which the current Product may be located.

At block 515, traffic and/or traffic delta to websites at which the Product is available may be obtained, such as according to Visitors 397 record. Visitors 397 record may record the webpage traffic to some or all Stores 386 at which the Product may be available, as such traffic may be attributed to the Product. This may be obtained from Ecommerce Platform 160 (separate Ecommerce Platform 160 instances may be associated with different Stores 386 records), from a service which tracks the number of Visitors 397 to Store 386 or to Product webpages at Store 386, or the like. The number of Visitors 397 may be relative to online outlets of Store 386, to physical stores, or both. Visitor 397 values may be obtained periodically, across all Stores 386. In addition to or as an alternative to use of Visitors 397 records, Sales Rank 388 record may be utilized. Sales Rank 388 record may record the rank of the Product in the sales for Store 386. As with Visitor 397 record, Sales Rank 388 may be used directly and/or a Sales Rank 388 delta may be used. The traffic or sales rank and/or a delta thereof may be normalized, such as relative to all Internet traffic for all Products or relative to traffic or sales rank for Products within a Category 335. Other metrics may be used as a contributor to Demand Signal, such as, for example, whether the Product has been listed in User List 307 or Custom List 307, which User List 307 may report Product information in the user interface for presenting the output of analysis of this information, further described in in U.S. application Ser. No. 61/952,004 and child applications thereof.

At block 520, the values of blocks 510 and 515 may be combined (such as by being summed, averaged, or the like) and stored as Demand Signal 301.

At block 525, Demand Signal Determination Process 500 returns to iterate over the next Product or, at block 599, may conclude if no additional Products remain.

FIG. 6 illustrates an example of Supply Signal Determination Process 600, in which Supply Signal 302 is determined. Blocks 605 to 665 may iterate for each Product as new data is available.

At block 610, the number of Stores 386 in which the then-current Product is (are) sold may be obtained and normalized, such as relative to number of Stores 386 at which other Products in the same Category 335 may be obtained or relative to the total number of Stores 386.

Blocks 615 to 625 may iterate for each Store 386 selling the Product on that iteration of blocks 605 to 665.

At block 620, Store Score 393 of each Store 386 may be obtained. At block 630, Store Score 393 of Stores 386 at which the Product is available may be averaged or otherwise combined.

At block 630, Price Changes 381 records of or associated with the then-current Product is (are) obtained and the frequency of price changes over a period of time is calculated. Price Changes 381 records may record information such as, for example, the price of a product, the date of the price, and the change in price across times.

At block 640, Price Changes 381 records of or associated with the then-current Product is (are) obtained and the magnitude of price changes over a period of time is calculated.

At block 645, Promotion 382 records of or associated with the then-current Product is (are) obtained and the frequency of promotions over a period of time is calculated. Promotion 382 records may record whether the Product has been on promotion. The promotion may be advertised or the promotion may be inferred, based on, for example, an average price, a suggested or stated retail price, or the like.

At block 650, Promotion 382 records of or associated with the then-current Product is (are) obtained and the magnitude of promotions over a period of time is calculated (such as according to a promotional percentage, such as 5%, 10%, etc.).

At block 655, Promotion 382 records of or associated with the then-current Product is (are) obtained and the duration of promotions over a period of time is calculated.

Not show, inventory levels of Product at Stores 386 may also be used as a factor in Supply Signal. Inventory levels may be obtained or may be determined from Availability 383 record.

At block 660, the values of the preceding blocks may be summed or otherwise combined and saved as Supply Signal 302.

At block 665, Supply Signal Determination Process 600 returns to iterate over the next Product or, at block 699, may conclude if no additional Products remain.

FIG. 7 illustrates an example of Social Signal Determination Process 700, in which Social Signal 303 is determined. Blocks 705 to 725 may iterate for each Product as new data is available.

At block 710, Brand Score 392 for Brand 394 associated with the Product may be obtained. At block 715, other Social Signals associated with the Product may be obtained, such as the number of normalized Likes 396, positive and negative “Tweets,” Followers 395, or similar associated with the Product may be obtained. Normalization may be performed relative to all Products or Products within the Category 335 in which the Product is located.

At block 720, the values from the preceding blocks may be summed or otherwise combined and saved as Social Signal 303.

At block 725, the Social Signal Determination Process 700 returns to iterate over the next Product or, at block 799, may conclude if no additional Products remain.

FIG. 8 illustrates an example of Quality Signal Determination Process 800, in which Quality Signal 304 is determined. Blocks 805 to 835 may iterate for each Product as new data is available.

Blocks 810 to 820 may iterate for each Store 386 selling the Product. At block 815, Store Score 393 may be obtained. At block 820, Quality Signal Determination Process 800 may return to block 810 to iterate over the next Store 386 selling the Product, if any. At block 825, Store Scores 393 of blocks 810 to 820 may be summed or otherwise combined. At block 830, the value of block 825 may be stored as Quality Signal 304.

Other information may be included in Quality Signal 304, such as consumer report rankings or the like.

At block 835, Quality Signal Determination Process 800 returns to iterate over the next Product or, at block 899, may conclude if no additional Products remain.

FIG. 9 illustrates Product-Type Quantity Signal Determination Process 900, in which Product-Type Quantity Signal 306 is determined. Blocks 905 to 920 may iterate for each Product as new data is available.

At block 910, a Brand 394 of the current Product may be determined and the number of Products by Brand 394 in the same Category 335 as the current Product may be obtained. This value may be normalized, such as relative to the number of Products by Brand 394 for other Products in the same Category 335 as the current Product.

At block 915, the number of Substitutes 387 for the Product may be obtained. Substitutes 387 may be obtained by looking at MPIDs 332 in the same Category 335 and within a price range, as described with respect to “Substitution Routine 800” in U.S. patent application Ser. No. 13/951,248. This value may be normalized, such as relative to the number of Substitutes 387 for other Products in the same Category 335 as the current Product.

At block 925, the values of the preceding blocks may be summed and stored as Product-Type Quantity Signal 306.

At block 920, Product-Type Quantity Signal Determination Process 900 returns to iterate over the next Product or, at block 999, may conclude if no additional Products remain.

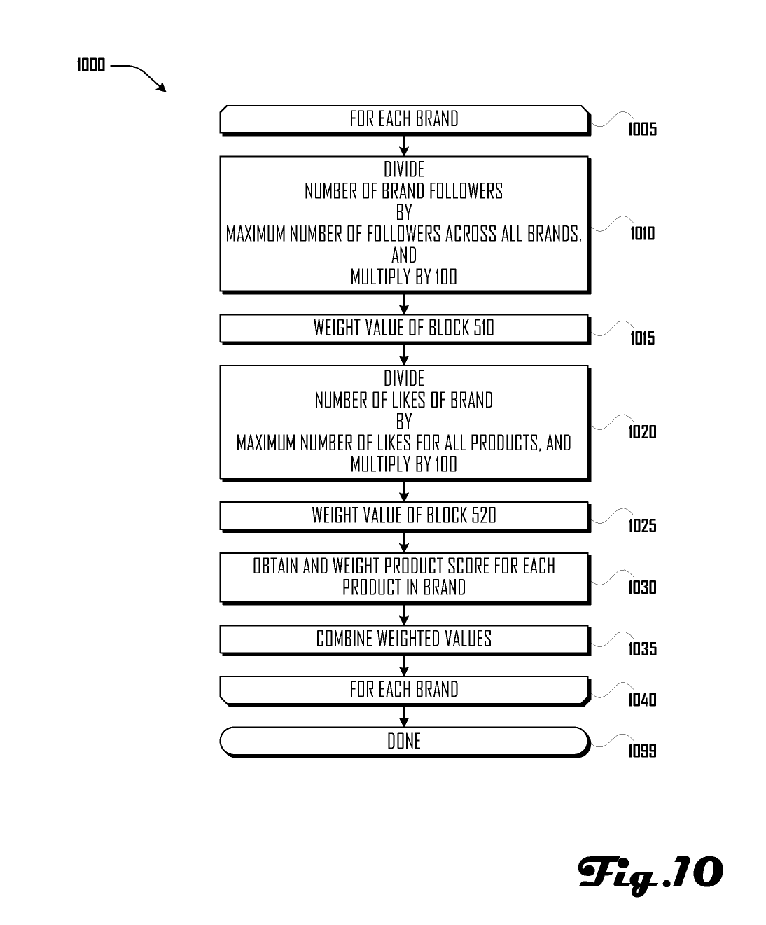

FIG. 10 illustrates Brand Score Determination Process 1000, in which Brand Score 392 is determined. Blocks 1005 to 1040 iterate separately over each Brand 394 in the Indix Database 300. Brands may be found in Product Attribute 345 records and may identify a trademark or tradename under which a Product is sold or marketed.

At block 1010, the number of Followers 395 of or associated with the then-current Brand 394 may be obtained, such as from one or more social media services with which Brand 394 may have an account. The social media services may be provided by, for example, Webserver 115. Followers 395 may be obtained periodically, across all Brands 394. The value may be normalized, such as by dividing the number of Followers 395 of or associated with the then-current Brand 394 by the maximum number of Followers 395 across all Brands 394. The result thereof may then be multiplied by 100.

At block 1015, the value obtained by block 1010 may be weighted, such as by multiplication by a percentage.

At block 1020, the number of Likes 396 of or associated with the then-current Brand 394 may be obtained, such as from one or more social media services with which the Brand 394 may have an account. The social media services may be provided by or obtained from, for example, Webserver 115. Likes 396 may be obtained periodically, across all Brands 394. This value may be normalized, for example, by dividing the number of Likes 396 of or associated with the then-current Brand 394 by the maximum number of Likes 396 across all Brands 394. The result thereof may then be multiplied by 100.

At block 1025, the value obtained by block 1020 may be weighted, such as by multiplication by a percentage.

At block 1030 Product Score 391 for each Product in the Brand 394 may be obtained and averaged.

At block 1035, the values of blocks 1015, 1025, and 1030 may be summed or otherwise combined.

At block 1040, Brand Score Determination Process 1000 may return to block 505 to iterate over the next Brand 394, if any.

At block 1099, Brand Score Determination Process 1000 may conclude.

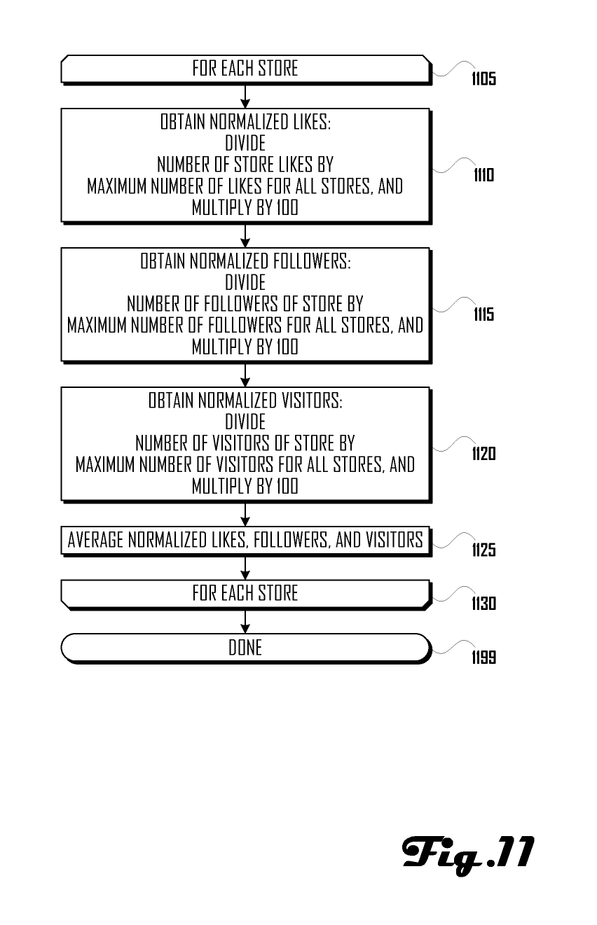

FIG. 11 illustrates Store Score Determination Process 1100, in which Store Score 393 is determined.

Blocks 1105 to 1130 iterate separately over each Store 386 in the Indix Database 300.

At block 1110, the number of Likes 396 of or associated with the then-current Store 386 may be obtained, such as from one or more social media services (with which the Store 386 may have an account). The social media services may be provided by, for example, Webserver 115. Like 396 values may be obtained periodically, across all Stores 386. This value may be normalized by, for example, dividing the number of Likes 396 of or associated with the then-current Store 386 may by the maximum number of Likes 396 of any single Store 386 across all Stores 386. The result thereof may then be multiplied by 100.

At block 1115, the number of Followers 395 of or associated with the then-current Store 386 may be obtained, such as from one or more social media services with which the Store 386 may have an account. The social media services may be provided by, for example, Webserver 115. Follower 395 values may be obtained periodically, across all Stores 386. This value may be normalized by, for example, dividing the number of Followers 395 of or associated with the then-current Store 386 by the maximum number of Followers 395 to any single Store 386 across all Stores 386. The result thereof may then be multiplied by 100.

At block 1120, the number of Visitors 397 of or associated with the then-current Store 386 may be obtained. This may be obtained from Store 386, from a service which tracks the number of Visitors 397 to Store 386, or the like. The number of Visitors 397 may be relative to online outlets of Store 386, to physical stores, or both. Visitor 397 values may be obtained periodically, across all Stores 386. This value may be normalized by, for example, dividing the number of Visitors 397 of or associated with the then-current Store 386 by the maximum number of Visitors 397 to any single Store 386 across all Stores 386. The result thereof may then be multiplied by 100.

At block 1125, the values of blocks 1110, 1115, and 1120 may be averaged or otherwise combined and saved as Store Score 393 for the then-current Store 386.

At block 1199, Store Score Determination Process 1100 may conclude.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

What is claimed is:

1. A method of determining a product score performed by a computer comprising a processor and a memory, which memory comprises instructions which, when executed, cause the processor and memory to perform the following:
with respect to a product:
obtain and weight a demand metric;
obtain and weight a supply metric;
obtain and weight a quality metric; and
determine the product score by combining the metrics.

2. The method of claim 1, further comprising ranking the products in a set of products based on the product score for each of the products in the set of products.

3. The method of claim 1, further comprising receiving a search term, determining a category associated with the search term and a set of products associated with the category, ranking the set of products according to the product score for each product in the set of products, and returning a result in response to the search term based on the ranked set of products.

4. The method of claim 1, wherein the demand metric is determined by normalizing and combining at least one of an availability metric, a sales rank metric, and a change in website traffic.

5. The method of claim 4, wherein the sales rank metric comprises a change in sales rank.

6. The method of claim 4, wherein the availability metric may be derived from a listing regarding the availability of the product on a website selling the product.

7. The method of claim 6, wherein the availability metric may comprise a change in availability between a first and a second listing on a webpage regarding the availability of the product.

8. The method of claim 1, wherein at least one of the supply metric and the quality metric further comprise a store score.

9. The method of claim 8, wherein the store score is determined by averaging a set of normalized likes, followers, and visitors to a website of the store.

10. The method of claim 8, wherein the supply metric is determined by combing a set of store scores for each store selling the product.

11. The method of claim 10, wherein determining the supply metric further comprises obtaining and combining a price change frequency for the product, a price change magnitude for the product, a promotion frequency for the product, a promotion magnitude for the product, and a promotion duration for the product.

12. The method of claim 1, further comprising obtaining, weighting, and combining with the other metrics a social impact metric.

13. The method of claim 12, wherein the social impact metric comprises a number of instances of the product in a social media and a brand score.

14. The method of claim 13, wherein the brand score is determined by summing a normalized number of followers of a brand associated with the product, a normalized number of likes of the brand associated with the product, and a product score for each product in the brand.

15. The method of claim 1, further comprising obtaining, weighting, and combining with the other metrics a product-type quantity metric.

16. The method of claim 15, wherein the product-type quantity metric is determined by obtaining a brand and a category associated with the product and obtaining a number of products in the same category and produced by the brand.

17. The method of claim 16, wherein the product-type quantity metric is further determined by obtaining a number of substitutes for the product and combining the number of substitutes with the number of products in the same category and produced by the brand.

18. The method of claim 8, wherein the quality metric is determined by combining a set of store scores for each store selling the product.

19. A system for determining a product score for a product, which system comprises a computer processor and a computer memory, which computer memory comprises instructions which, when executed, cause the system to perform the following:
with respect to a product:
obtain and weight a demand metric;
obtain and weight a supply metric;
obtain and weight a quality metric; and
determine the product score by combining the metrics.

20. A computer readable medium comprising instructions which, when executed by a computer comprising a processor and a memory, perform a method of determining a product score, which method comprises:
with respect to a product:
obtaining and weighting a demand metric;
obtaining and weighting a supply metric;
obtaining and weighting a quality metric; and
determining the product score by combining the metrics.
